(19) United States
(12) Patent Application Publication
(10) Pub. No.: US 2026/0132057 A1
(43) Pub. Date: May 14, 2026

(54) FLUID STERILIZATION DEVICE

(71) Applicant: TOYODA GOSEI CO., LTD., Kiyosu-shi (JP)

(72) Inventor: Satoshi WADA, Kiyosu-shi (JP)

(21) Appl. No.: 19/024,089

(22) Filed: Jan. 16, 2025

(30) Foreign Application Priority Data
Jan. 17, 2024 (JP) 2024-004983

(51) Int. Cl. C02F 1/32

(52) U.S. Cl. CPC C02F 1/325; C02F 2201/002; C02F 2201/3222; C02F 2201/3225

(57) ABSTRACT

A fluid sterilization device includes: a flow path tube through which a fluid flows, the flow path tube having a cylindrical tube shape; and a light source unit configured to irradiate an inside of the flow path tube with ultraviolet light. The flow path tube includes a transparent tube through which the ultraviolet light is transmitted, and aluminum film wound around an outer peripheral surface of the transparent tube. The aluminum film is disposed not to be in close contact with at least a portion of the outer peripheral surface of the transparent tube and to have a first air layer.

### CROSS-REFERENCE TO RELATED APPLICATIONS

This application is based on and claims priority under 35 USC 119 from Japanese Patent Application No. 2024-004983 filed on Jan. 17, 2024, the entire content of which is incorporated herein by reference.

### TECHNICAL FIELD

The present invention relates to a fluid sterilization device.

### BACKGROUND ART

A sterilization device that sterilizes and inactivates bacteria and viruses in running water by irradiating the water with ultraviolet light is known. A mercury lamp is widely used as a light source.

Since the mercury lamp uses mercury and thus the mercury lamp is highly toxic, there is a problem that the mercury lamp has a large environmental load. Further, there is also a problem that using a mercury lamp results in an increase in size of the sterilization device. Therefore, the mercury lamp has been replaced with an ultraviolet LED.

JP2018-118201A discloses a sterilization device that includes a flow path tube through which a fluid flows, and a light source that emits ultraviolet light toward the fluid in the flow path tube from one end of the flow path tube. Further, JP2018-118201A discloses a configuration in which a reflective film is provided on an outer peripheral surface of a transparent quartz tube as a flow path tube, and describes that the reflective film is an aluminum vapor-deposited film.

### SUMMARY OF INVENTION

However, in JP2018-118201A, the reflective film is formed by vapor deposition, which is time-consuming and increases costs.

Aspects of the present disclosure relates to providing a fluid sterilization device that is low-cost and includes a flow path tube having high reflectance.

According to an aspect of the present disclosure, there is provided A fluid sterilization device including:
a flow path tube through which a fluid flows, the flow path tube having a cylindrical tube shape; and
a light source unit configured to irradiate an inside of the flow path tube with ultraviolet light, in which
   the flow path tube includes
      a transparent tube through which the ultraviolet light is transmitted, and
      aluminum film wound around an outer peripheral surface of the transparent tube, and
   the aluminum film is disposed not to be in close contact with at least a portion of the outer peripheral surface of the transparent tube and to have a first air layer.

In the above aspect, the aluminum film is disposed not to be in close contact with at least a portion of the outer peripheral surface of the transparent tube and to have the first air layer. Therefore, reflection may be caused at an interface between the transparent tube and the first air layer and an interface between the first air layer and the aluminum film. Therefore, a fluid sterilization device that is low-cost and includes a flow path tube having high reflectance may be achieved.

### BRIEF DESCRIPTION OF DRAWINGS

Exemplary embodiment(s) of the present invention will be described in detail based on the following figures, wherein:

FIG. 1 is a perspective view illustrating a configuration of a fluid sterilization device according to Embodiment 1;

FIG. 2 is a view illustrating the configuration of the fluid sterilization device according to Embodiment 1, and is a cross-sectional view taken along line II-II in FIG. 1;

FIG. 3 is a view illustrating the configuration of the fluid sterilization device according to Embodiment 1, and is a cross-sectional view taken along line III-III in FIG. 1;

FIG. 4 is a view illustrating the configuration of the fluid sterilization device according to Embodiment 1, and is a cross-sectional view taken along line IV-IV in FIG. 1;

FIG. 5A is a view illustrating the configuration of the fluid sterilization device according to Embodiment 1 and is a cross-sectional view taken along line Va-Va in FIG. 1;

FIG. 5B is a view illustrating the configuration of the fluid sterilization device according to Embodiment 1 and is a cross-sectional view taken along line Vb-Vb in FIG. 1;

FIG. 6A is a view schematically illustrating a flow of a fluid near an inlet and is a view illustrating a first end portion 100a side;

FIG. 6B is a view schematically illustrating a flow of a fluid near an inlet and is a view illustrating a second end portion 100b side;

FIGS. 7A, 7B and 7C are views schematically illustrating a configuration of a light source unit of a fluid sterilization device according to Modification 1 of Embodiment 1;

FIG. 8 is a cross-sectional view of a flow path tube according to Modification 6 of Embodiment 1;

FIGS. 9A and 9B are plan views of an aluminum film in a flat state before being wound around a transparent tube; and

FIG. 10 is a cross-sectional view of a flow path tube according to Modification 7 of Embodiment 1.

### DESCRIPTION OF EMBODIMENTS

A fluid sterilization device includes a flow path tube through which a fluid flows, the flow path tube having a cylindrical tube shape, and a light source unit that irradiates an inside of the flow path tube with ultraviolet light. The flow path tube includes a transparent tube through which the ultraviolet light is transmitted, and an aluminum film wound around an outer peripheral surface of the transparent tube. The aluminum film is disposed not to be in close contact with at least a portion of the outer peripheral surface of the transparent tube and to have a first air layer.

In the fluid sterilization device, the aluminum film may be wound such that the aluminum film is wound such that the aluminum film overlaps to have a first portion of the aluminum film on a second portion of the aluminum film, and an adhesive layer is provided between the first portion and the second portion.

In the fluid sterilization device, the aluminum film may be disposed to have the first air layer between the aluminum film and the outer peripheral surface of the transparent tube entirely. Reflectance of the flow path tube may be further increased.

The fluid sterilization device may further include an adhesive layer on a portion of an inner surface of the aluminum film. The transparent tube and the aluminum film may be adhered by the adhesive layer. The first air layer may be present around the adhesive layer. In this case, the adhesive layer may have a periodic pattern. The first air layer may be formed by adhering the aluminum film to the transparent tube while allowing the adhesive layer to function as a spacer.

In the fluid sterilization device, the flow path tube may further include a light-shielding tube that covers an outer periphery of the aluminum film and shields the ultraviolet light from the light source unit. Leakage of ultraviolet light from the flow path tube to an outside may be prevented.

The fluid sterilization device may further include a second air layer between the aluminum film and the light-shielding tube. The reflectance may be further increased.

In the fluid sterilization device, the aluminum film may be wound in a cylindrical tube shape that is C-shaped, the light-shielding tube may include a protrusion that protrudes inward on an inner peripheral surface thereof, and the protrusion may be fitted into a gap in the aluminum film formed by the C-shaped. Displacement of the aluminum film may be prevented.

### Embodiment 1

### 1. Overview of Configuration of Fluid Sterilization Device 1

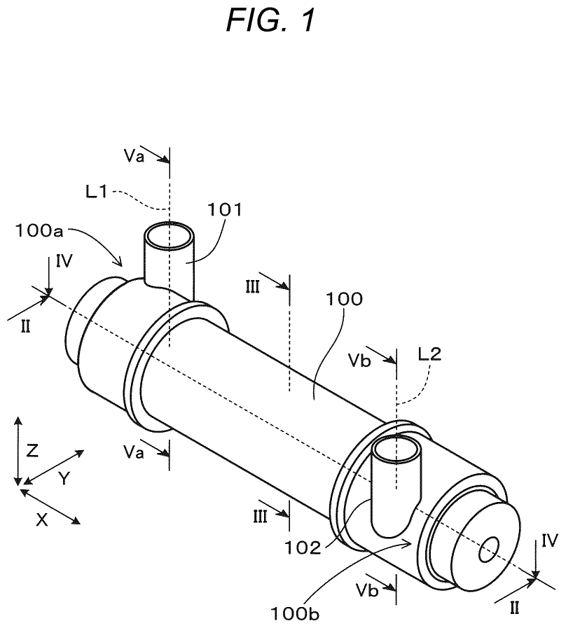

FIG. 1 is a perspective view illustrating a configuration of a fluid sterilization device 1 according to Embodiment 1. As illustrated in FIG. 1, the fluid sterilization device 1 according to Embodiment 1 includes a flow path tube 100 and two light source units 110 therein. In FIG. 1, an X-axis is taken in a direction of a central axis O of the flow path tube 100, a Y-axis is taken in a direction orthogonal to the X-axis and orthogonal to a central axis L1 of an inlet, and a Z-axis is taken in a direction perpendicular to the X-axis and the Y-axis.

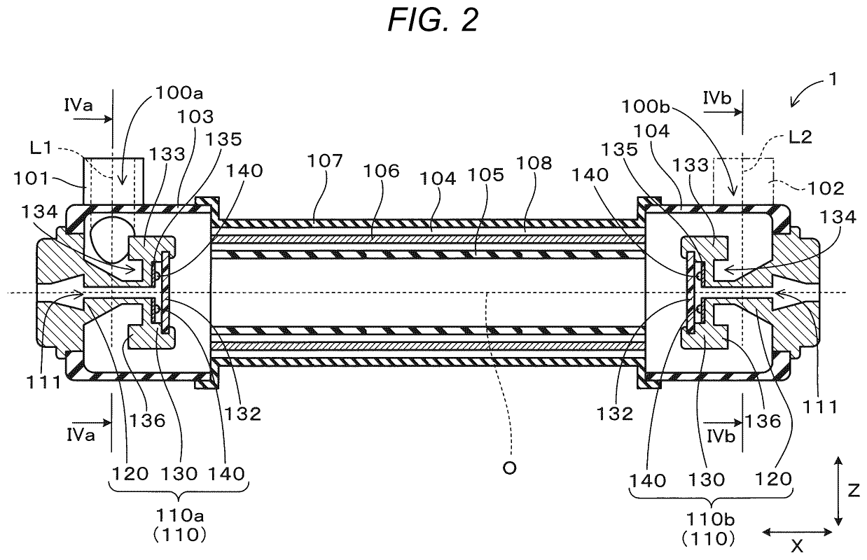

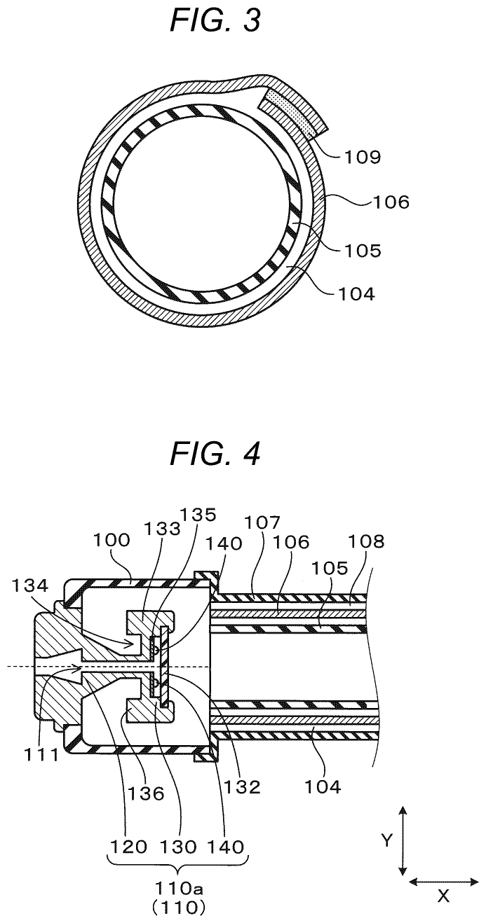

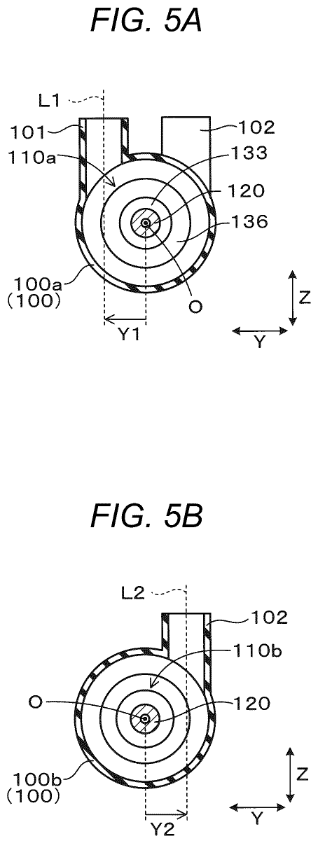

FIG. 2 is a cross-sectional view illustrating the configuration of the fluid sterilization device 1 according to Embodiment 1, and illustrates a cross section (ZX plane) taken along line II-II in FIG. 1. As illustrated in FIG. 2, inside the flow path tube 100, the light source units 110 are respectively disposed at both ends of the flow path tube 100. FIG. 3 is a view schematically illustrating a cross section (YZ plane) of a central portion of the flow path tube 100, taken along line III-III in FIG. 1. FIG. 4 is a cross-sectional view illustrating the configuration of the fluid sterilization device according to Embodiment 1, and is a view illustrating a portion of a cross section (XY plane) taken along IV-IV in FIG. 1 (on a first end portion 100a side). FIGS. 5A and 5B are cross-sectional views illustrating the configuration of the fluid sterilization device 1 according to Embodiment 1. FIG. 5A is a cross-sectional view (YZ plane) taken along Va-Va in FIG. 1, and FIG. 5B is a cross-sectional view (YZ plane) taken along Vb-Vb in FIG. 1.

The fluid sterilization device 1 according to Embodiment 1 is a device that causes a fluid to flow from an inlet 101 of the flow path tube 100 to a flow path space inside the flow path tube 100, irradiates the fluid with ultraviolet light from the light source unit 110 to sterilize the fluid, and discharges the sterilized fluid from an outlet 102. The fluid to be sterilized may be a gas or a liquid, and may be a mixture of a gas and a liquid, a mixture of a gas and a powdery solid, or the like as long as the fluid has fluidity. When the fluid is a liquid, examples thereof include water, oil, alcohol, and a solution containing the same as a solvent.

### 2. Details of Each Configuration of Fluid Sterilization Device 1

Next, each configuration of the fluid sterilization device 1 according to Embodiment 1 will be described in detail.

### 2-1. Configuration of Flow Path Tube 100

The flow path tube 100 has a cylindrical tube shape and has a cylindrical column-shaped space therein. This space is a flow path space through which the fluid to be sterilized flows. Both ends of the flow path tube 100 are each provided with a light source unit 110. Here, one end portion of the flow path tube 100 is referred to as a first end portion 100a, and the other end portion of the flow path tube 100 is referred to as a second end portion 100b. One of the two light source units 110 provided on the first end portion 100a side is referred to as a light source unit 110a, and the other of the two light source units 110 provided on a second end portion 100b side is referred to as a light source unit 110b. Further, a side wall of the flow path tube 100 on the first end portion 100a side is provided with the inlet 101, and a side wall of the flow path tube 100 on the second end portion 100b side is provided with the outlet 102. The inlet 101 and the outlet 102 have a cylindrical tube shape and have a flow path region through which the fluid flows.

As illustrated in FIGS. 2 and 3, the central portion of the flow path tube 100 includes a transparent tube 105, an aluminum film 106, and a light-shielding tube 107.

The transparent tube 105 is a cylindrical tube made of quartz. The first end portion 100a of the flow path tube 100 is connected to one end portion of the transparent tube 105, and the second end portion 100b of the flow path tube 100 is connected to the other end portion of the transparent tube 105. Therefore, a cylindrical column-shaped flow path space is continuous from the first end portion 100a to the second end portion 100b through the transparent tube 105.

A material of the transparent tube 105 is not limited to quartz, and any material that transmits ultraviolet light and has low absorptivity may be used. For example, sapphire, ultraviolet light-transmitting glass, fluororesin, acrylic resin, or the like may be used. In particular, a material having a small difference in refractive index from water is preferable, and in this respect, the quartz in Embodiment 1 is preferable. For example, a material having a refractive index of 1.3 to 1.5 is preferable.

A thickness of the transparent tube 105 may be any thickness as long as the thickness is within a range that provides strength capable of withstanding water pressure and ultraviolet light transmittance, and is, for example, 0.4 to 3.0 mm. In the case of vertical incidence, a material and a thickness having an ultraviolet light transmittance of 80% or more are preferable.

An inner peripheral surface of the transparent tube 105 is preferably as flat as possible, and for example, a root mean square height (RMS) is preferably 1 μm or less. Bacteria are less likely to adhere to unevenness of the inner peripheral surface, the inner peripheral surface is less likely to be contaminated, and a decrease in sterilization efficiency may be prevented. Further, a resistance of the inner wall surface decreases, allowing the flow to be easily maintained. The range between 0.2 nm and 1.0 μm is more preferable.

A water-repellent film such as fluororesin may be formed on the inner peripheral surface of the transparent tube 105 so that the inner peripheral surface of the transparent tube 105 repels water, thereby preventing contamination of the inner peripheral surface of the transparent tube 105. Further, a photocatalytic film that is excited by ultraviolet light and exhibits a photocatalyst effect may be formed on the inner peripheral surface of the transparent tube 105, and contamination of the inner peripheral surface of the transparent tube 105 may be prevented by the photocatalytic film effect.

The aluminum film 106 is a flat strip-shaped film, and as illustrated in FIGS. 2 and 3, is wound in a cylindrical tube shape around an outer peripheral surface of the transparent tube 105 and covers the entire outer peripheral surface of the transparent tube 105. The aluminum film 106 is wound such that the aluminum films 106 partially overlap each other. In the overlapping region, the aluminum films 106 are adhered to each other by an adhesive layer 109 and maintain the cylindrical tube shape. Further, the aluminum film 106 is adhered to the first end portion 100a, the second end portion 100b, the light-shielding tube 107, and the like of the flow path tube 100 by the adhesive layer 109, and a position of the aluminum film 106 is fixed. As described above, since the aluminum film 106 is adhered in a region that is not exposed to ultraviolet light, deterioration of an adhesive due to ultraviolet light may be prevented. The aluminum film 106 may be wound two times or more.

The aluminum film 106 is made of aluminum or an alloy containing aluminum as a main component. Since aluminum is a material having high reflectance of ultraviolet light, the reflectance of ultraviolet light may be easily increased by winding the aluminum film 106 around the transparent tube 105.

The aluminum film 106 is disposed not to be in contact with the entire outer peripheral surface of the transparent tube 105, and an air layer 104 is present between the transparent tube 105 and the aluminum film 106. By providing the air layer 104 in this manner, reflection may be caused at an interface between the transparent tube 105 and the air layer 104 and an interface between the air layer 104 and the aluminum film 106. As a result, an irradiation intensity of the ultraviolet light to the fluid flowing inside the transparent tube 105 may be increased, and the sterilization efficiency may be improved.

A thickness of the aluminum film 106 is preferably 3 μm or more and 1 mm or less. Within this range, the reflectance may be sufficiently improved, and the aluminum film 106 may be easily wound around the transparent tube 105.

A thickness of the air layer 104 (distance between the transparent tube 105 and the aluminum film 106) is preferably 0.1 μm or more and 1 mm or less. By setting the thickness in this range, reflection may be efficiently caused at the interface between the transparent tube 105 and the air layer 104 and the interface between the air layer 104 and the aluminum film 106.

In Embodiment 1, the entire outer peripheral surface of the transparent tube 105 is not in contact with the aluminum film 106. However, it is sufficient that at least a portion of the outer surface is not in contact with the aluminum film 106. It is preferable that 70% or more of an area of the outer peripheral surface of the transparent tube 105 is not in contact with the aluminum film 106.

The light-shielding tube 107 is a cylindrical tube, and is disposed outside the transparent tube 105 to enclose the transparent tube 105 while sharing the same axis. The aluminum film 106 and the light-shielding tube 107 are disposed with a gap therebetween, and an air layer 108 is present. The light-shielding tube 107 is made of a material that does not transmit ultraviolet light. By providing the light-shielding tube 107 to shield ultraviolet light, leakage of ultraviolet light from the flow path tube 100 to the outside may be prevented. In addition, since the air layer 108 may cause reflection due to differences in refractive index, leakage of ultraviolet light may be further prevented.

The light-shielding tube 107 is made of a material that absorbs ultraviolet light. For example, it is a material obtained by mixing a resin such as polypropylene, ABS, polyphenylene ether, polycarbonate, polyvinyl chloride, or polyacetal with a carbon material such as carbon black, graphite, or carbon nanotubes.

Examples of a material for the first end portion 100a and the second end portion 100b of the flow path tube 100 include a stainless steel (SUS), titanium, and polytetrafluoroethylene (PTFE). An inner wall surface of a resin material resistant to ultraviolet light may be covered with a material having high reflectance of ultraviolet light. The resin material having resistance to ultraviolet light is, for example, vinyl chloride. Further, examples of the material having high reflectance of the ultraviolet light include aluminum and PTFE. Further, an outer wall surface of a material that transmits ultraviolet light may be covered with a material having high reflectance of ultraviolet light. Examples of the material that transmits ultraviolet light include sapphire, ultraviolet light-transmitting glass, fluororesin, and acrylic resin.

As illustrated in FIG. 5A, the inlet 101 is disposed such that an inflow direction of the fluid that flows in from the inlet 101 is offset from the central axis O of the flow path tube 100. That is, a flow path central axis, which is a central axis of the flow path region of the inlet 101 (hereinafter, simply referred to as a central axis of the inlet 101) L1 coincides with a direction which is parallel to a line intersecting the central axis O of the flow path tube 100 and does not intersect the central axis O of the flow path tube 100. When viewed in cross section as illustrated in FIG. 5A, the central axis L1 of the inlet 101 is disposed offset by Y1 in a Y direction not to pass through the central axis O of the flow path tube 100. By offsetting a position of the inlet 101 in this manner, a helical flow may be formed in the flow path space in the flow path tube 100, and a tangential direction of the helical flow is a direction of the central axis L1 of the inlet 101. Further, as illustrated in FIG. 2, the central axis L1 of the inlet 101 and the central axis O form an angle of 90 degrees. The angle does not necessarily have to be 90 degrees and is preferably 80 to 100 degrees.

As illustrated in FIG. 5B, an outflow direction of the outlet 102 is also disposed offset from the central axis O of the flow path tube 100. That is, a flow path central axis, which is a central axis of the flow path region of the outlet 102 (hereinafter, simply referred to as a central axis of the outlet 102) L2 coincides with a direction which is parallel to a line intersecting the central axis O of the flow path tube 100 and does not intersect the central axis O of the flow path tube 100. When viewed in cross section as illustrated in FIG. 5B, the central axis L2 of the outlet 102 is disposed offset by Y2 in a Y direction not to pass through the central axis O of the flow path tube 100. Accordingly, the helical flow may be maintained even on an outlet 102 side, and the tangential direction of the helical flow is a direction of the central axis L2 of the outlet 102. Y1 and Y2 may be different from each other. However, Y1 and Y2 are preferably values as close as possible, and particularly preferably the same value.

### 2-2. Configuration of Light Source Unit 110

The light source unit 110 includes LED packages 140, a support portion 120, and an accommodation portion 130. Hereinafter, the light source unit 110a provided on the first end portion 100a side will be described, and the light source unit 110b provided on the second end portion 100b side has the same configuration.

As illustrated in FIG. 2, the support portion 120 protrudes from the first end of the flow path tube 100 toward the second end, and has a truncated cone-shaped portion. A central axis of the support portion 120 coincides with the central axis O of the flow path tube 100. An inclination angle of a side surface of the truncated cone (angle to a bottom surface) is, for example, 30 to 70°. One end of the support portion 120 on a side with a larger diameter is connected to the first end of the flow path tube 100, and one end of the support portion 120 on a side with a smaller diameter is connected to the accommodation portion 130.

A shape of the support portion 120 is not limited to a truncated cone shape, and may be any shape that tapers toward the second end of the flow path tube 100. Although the shape may be tapered in a stepwise manner, it is preferable that the shape is continuously tapered. For example, a truncated pyramid shape may be used. However, in order to form a helical flow, a truncated cone shape is preferable. Further, the entire support portion 120 may not be a truncated cone, and one portion may be a truncated cone and the other portion may be a column. For example, as illustrated in FIG. 1, a side of a front end of the support portion 120 connected to the accommodation portion 130 may have a cylindrical column shape, and the other portion may have a truncated cone shape.

The accommodation portion 130 is connected to the front end of the support portion 120. The accommodation portion 130 accommodates the LED packages 140. The accommodation portion 130 includes a glass plate 132, a base portion 133, and a substrate 135.

The base portion 133 has a cylindrical column-shaped box shape whose upper surface is opened, and an outside bottom surface is connected to the front end of the support portion 120. The substrate 135 is disposed on a bottom surface inside the box, and the LED packages 140 are mounted on the substrate 135. The glass plate 132 is provided on an upper surface of the box and seals an inside of the box. The glass plate 132 is made of a material that transmits ultraviolet light from the LED packages 140, such as quartz or sapphire. A photocatalytic film that transmits the ultraviolet light may be provided on a surface of the glass plate 132 to inhibit propagation of bacteria and prevent organic contamination on the glass plate 132. The glass plate 132 is not limited to a flat plate, and may be lenticular. For example, the glass plate 132 may be a TIR lens, a fly-eye lens, and a Fresnel lens.

As illustrated in FIG. 2, the base portion 133 is formed to extend from the front end of the support portion 120 to an outside of the support portion 120 in a radial direction over an entire periphery of the front end of the support portion 120. Therefore, a back surface of the base portion 133 is in contact with the flow path space except for a region connected to the support portion 120.

The base portion 133 includes a peripheral wall 136 that protrudes toward the first end in an outer peripheral region of the back surface thereof, and includes a recess 134 surrounded by the back surface of the base portion 133 and the peripheral wall 136. In Embodiment 1, the peripheral wall 136 does not need to be provided over the entire peripheral, and may be partially provided. If the peripheral wall 136 is provided over the entire peripheral, air may be accumulated in the recess 134 and the cooling efficiency may be reduced. Further, it is preferable that the peripheral wall 136 is provided outside the LED packages 140 when viewed from a central axis direction of the flow path tube 100. That is, it is preferable that the LED packages 140 are positioned in a region of the recess 134. The base portion 133 may be more efficiently cooled.

In Embodiment 1, the base portion 133 has a cylindrical column-shaped box shape, and any shape may be used as long as it has a box shape. For example, the base portion 133 may have a square prism-shaped box shape (square shape). However, from a viewpoint of generating a helical flow, it is preferable to form a cylindrical column-shaped box as that in Embodiment 1.

A material for the support portion 120 and the base portion 133 is titanium. Other than titanium, for example, a metal material having high thermal conductivity such as SUS or aluminum, or a high heat dissipation resin mixed with a thermally conductive filler may be used.

The LED packages 140 are mounted on the substrate 135. A plurality of LED packages 140 may be mounted. Two LED packages 140 are mounted in FIG. 2. The LED package 140 includes an LED, a substrate on which the LED is mounted, and a lens that seals the LED.

The LED is a light-emitting element that emits ultraviolet light. A wavelength of the ultraviolet light is preferably 250 to 285 nm, which is a wavelength having high sterilization efficiency. A plurality of LEDs may be provided in one LED package 140.

It is preferable that the LED package 140 is mounted in a region outside the support portion 120 when viewed from the central axis direction of the flow path tube 100. Since the fluid may be brought into contact with a region of the back surface of the base portion 133 directly below the LED package 140, the accommodation portion 130 may be efficiently cooled.

In Embodiment 1, the packaged LED package 140 is mounted on the substrate 135. The LED may be directly mounted on the substrate 135.

A through continuous hole 111 is provided at a center of the support portion 120 and the accommodation portion 130. The hole 111 is a hole through which a wiring cable that supplies power to the LED package 140 and circuit components on a mounting substrate is inserted. The wiring cable is drawn into the mounting substrate through the hole 111.

### 3. Flow Path of Fluid

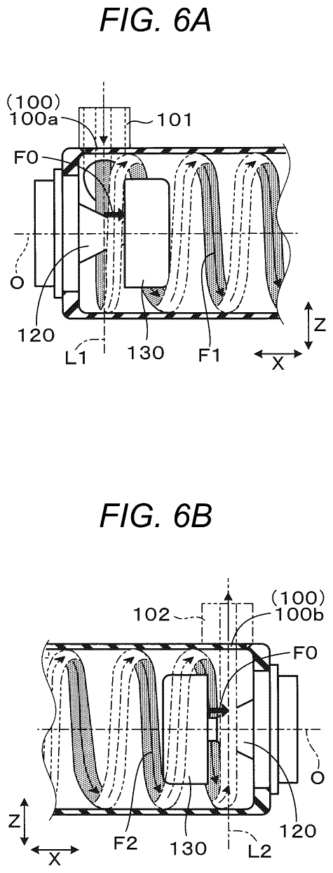

A flow path of the fluid flowing in the flow path tube 100 will be described with reference to FIGS. 6A and 6B. FIG. 6A is a view schematically illustrating a flow path on the first end portion 100a side (inlet 101 side) of the flow path tube 100, and FIG. 6B is a view schematically illustrating a flow path on the second end portion 100b side (outlet 102 side) of the flow path tube 100.

As illustrated in FIG. 6A, the fluid entering the flow path space in the flow path tube 100 from the inlet 101 flows to circulate around the support portion 120 of the light source unit 110a. This is because the inlet 101 is offset from the central axis O of the flow path tube 100, and a position, a shape, and a size of the inlet 101 are set to circulate around the support portion 120. When viewed in the direction of the central axis O of the flow path tube 100, that is, the direction from the first end portion 100a toward the second end portion 100b, the fluid flows to rotate counterclockwise.

The fluid that circulates around the support portion 120 hits the side surface of the truncated conical portion of the support portion 120. Therefore, the fluid is reflected in an axial direction due to an inclination of the side surface, and a flow path toward the accommodation portion 130 is formed. Therefore, the fluid may be efficiently brought into contact with the accommodation portion 130, and the cooling efficiency may be improved.

Further, since the base portion 133 is formed to extend from the front end of the support portion 120 to the outside of the support portion 120 in the radial direction along the entire periphery of the front end of the support portion 120, the fluid may be brought into contact with the back surface of the base portion 133. In particular, the fluid is brought into contact with the region of the back surface of the base portion 133 which is directly below the LED package 140. Therefore, the base portion 133 may be efficiently cooled.

Further, since the peripheral wall 136 is provided on the back surface of the base portion 133 and the recess 134 surrounded by the peripheral wall 136 exists, the fluid easily remains on the back surface of the base portion 133. Therefore, heat may be efficiently conducted from the back surface of the base portion 133 to the fluid, and the cooling efficiency may be improved.

Thereafter, the fluid flows in the central axis direction while rotating around the central axis O in a ring-shaped region between the accommodation portion 130 and the inner wall surface of the flow path tube 100. As a result, a helical flow F1 is formed. By forming the helical flow F1, residence time of the fluid in the flow path space is increased, and irradiation time of the ultraviolet light to the fluid is increased, thereby improving the sterilization efficiency.

On the other hand, on the second end portion 100b side, a helical flow F2 is maintained as illustrated in FIG. 6B. This is because a clean helical flow F1 is formed on the first end portion 100a side, and the helical flow F1 is less likely to collapse even at a distant position. Therefore, the irradiation time of ultraviolet light is longer on the second end portion 100b side as well, and the sterilization efficiency may be improved.

Further, on the second end portion 100b side, the fluid passes through the ring-shaped region between the accommodation portion 130 of the light source unit 110b and the inner wall surface of the flow path tube 100 in the direction of the central axis O while rotating around the central axis O. Then, the fluid flows out from the outlet 102 while circulating around the support portion 120 of the light source unit 110b. Similarly to the inlet 101, the outlet 102 is also offset from the central axis O of the flow path tube 100, and a position, a shape, and a size of the outlet 102 are set to circulate around the support portion 120, so that the fluid may smoothly flow out from the outlet 102, reducing pressure loss.

A portion of the fluid that circulates around the support portion 120 of the light source unit 110b is reflected by the side surface of the support portion 120, forming a flow path F0 toward the accommodation portion 130 of the light source unit 110b. Therefore, the accommodation portion 130 of the light source unit 110b may be efficiently cooled.

### 5. Summary

As described above, in the fluid sterilization device 1 according to Embodiment 1, the flow path tube 100 includes the transparent tube 105 and the aluminum film 106 wound around the transparent tube 105. Therefore, the ultraviolet light reflectance of the inner wall surface of the flow path tube 100 may be easily improved at low cost.

### Modification 1 of Embodiment 1

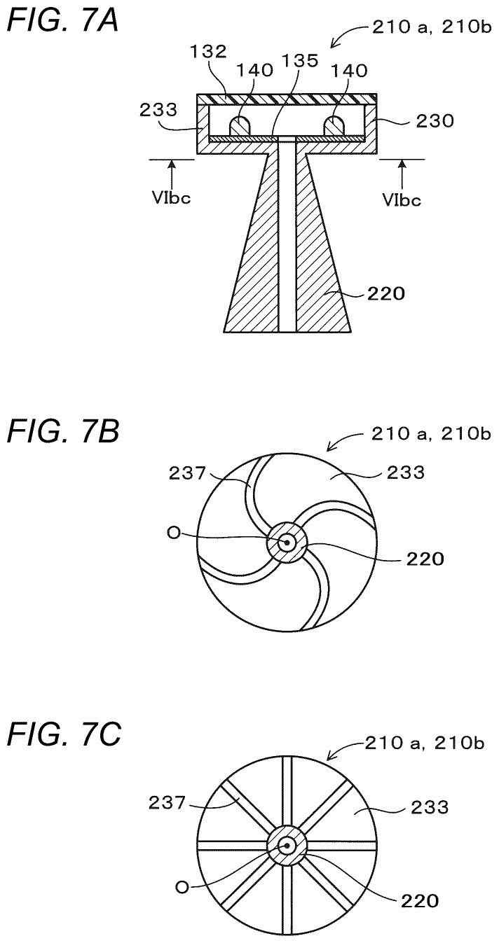

FIGS. 7A, 7B, and 7C are views schematically illustrating a configuration of a light source unit 210 of a fluid sterilization device according to Modification 1 of Embodiment 1. As illustrated in FIG. 7A, the light source unit 210 includes the support portion 220 and an accommodation portion 230. The support portion 220 has the same configuration as the support portion 120 according to Embodiment 1. The accommodation portion 230 has a configuration in which the base portion 133 of the accommodation portion 130 according to Embodiment 1 is replaced with a base portion 233, and other configurations are the same as those of the accommodation portion 130. The base portion 233 has a configuration in which the peripheral wall 136 is eliminated from the base portion 133, and an outer peripheral region on a back surface of the base portion 233 is flat.

Further, in Modification 1 of Embodiment 1, although the effect of retaining the fluid on the back surface of the accommodation portion 230 is not obtained by the peripheral wall 136, other effects may be obtained in the same manner as in Embodiment 1.

In Modification 1 of Embodiment 1, in the light source unit 210 on the inlet 101 side, a groove 237 may be provided on the back surface of the accommodation portion 230 (back surface of the base portion 233), and the fluid may be guided from a center side to an outer periphery side of the back surface of the accommodation portion. Alternatively, a wall-shaped protrusion may be provided instead of the groove 237.

FIGS. 7B and 7C are each a cross-sectional view illustrating a cross section taken along line VIbc-VIbc in FIG. 7A. FIG. 7B illustrates a case in which a helical groove 237 is provided on the back surface of the base portion 233. A center of the helical is a center of the support portion 220. By providing such a helical groove 237, contact time between the fluid and the accommodation portion 230 is increased, so that the accommodation portion 230 may be efficiently cooled. Further, a flow path swirling toward the outer periphery of the back surface of the accommodation portion 230 may be formed, and the fluid passing between an inner wall of the flow path tube 100 and the accommodation portion 230 easily forms a helical flow.

FIG. 7C illustrates a case in which a radial groove 237 is provided on the back surface of the base portion 233. By providing such groove 237, the fluid may be guided to the outer periphery.

The light source unit 210 on the outlet 102 side may also be provided with the groove 237 as illustrated in FIGS. 7B and 7C. The accommodation portion 230 may be efficiently cooled. Further, the fluid that passes between the inner wall of the flow path tube 100 and the accommodation portion 230 may be guided to the support portion 220, and then a smooth flow path toward the outlet 102 may be formed through reflection by the support portion 220.

### Modification 2 of Embodiment 1

The support portion 120 may have a cylindrical column shape. Although there is no effect of causing the fluid to the accommodation portion 130, other effects may be obtained in the same manner as in Embodiment 1. The accommodation portion 130 may be the same as that in Embodiment 1.

### Modification 3 of Embodiment 1

The back surface of the base portion 133 may coincide with the front end of the support portion 120, and no portion may protrude outside the support portion 120 in the radial direction. Although the fluid cannot be brought into contact with the back surface of the accommodation portion 130 for cooling, other effects may be obtained in the same manner as in Embodiment 1.

### Modification 4 of Embodiment 1

A light intensity sensor may be provided at a central portion of the flow path tube 100. The light intensity sensor is a sensor that detects an intensity of the ultraviolet light in the central portion of the flow path tube 100. For example, outputs of the two light source units 110 are controlled such that the intensity of the ultraviolet light in the central portion is equal to or greater than a predetermined value or more.

Further, the light intensity sensor also serves as a flow guide plate. The light intensity sensor is a wall-shaped protrusion that is provided on the inner wall of the flow path tube 100 and protrudes toward the central axis of the flow path tube 100. The light intensity sensor has a wall shape along a direction of the helical flow, thereby allowing the helical flow to be maintained in the central portion of the flow path tube 100.

### Modification 5 of Embodiment 1

A helical groove 700 may be provided in the inner wall of the flow path tube 100. By providing the helical groove 700 in the flow path tube 100, the helical flow may be easily maintained in the flow path space, and the sterilization efficiency may be improved.

### Modification 6 of Embodiment 1

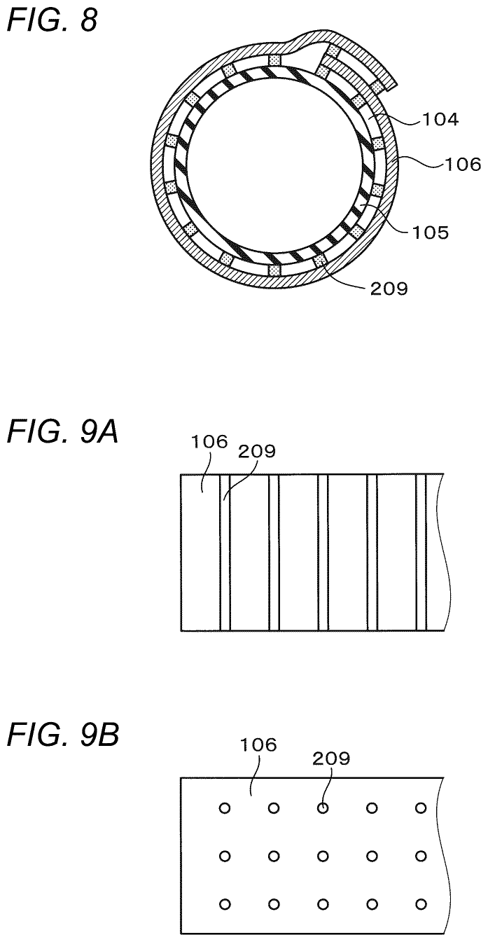

In Modification 6 of Embodiment 1, the flow path tube 100 according to Embodiment 1 is changed as follows. FIG. 8 is a cross-sectional view of a flow path tube 100 according to Modification 6 of Embodiment 1, and FIGS. 9A and 9B are plan views of an aluminum film 106 in a flat state before being wound around a transparent tube 105.

As illustrated in FIGS. 9A and 9B, an adhesive layer 209 is provided on an inner surface of the aluminum film 106 (main surface that faces the transparent tube 105 when the aluminum film 106 is wound around the transparent tube 105). The adhesive layer 209 is not entirely provided, and has a periodic pattern. That is, it is a pattern in which regions with and without the adhesive layer 209 alternate. The periodic pattern may be a one-dimensional periodic pattern or a two-dimensional periodic pattern, for example, a stripe pattern as illustrated in FIG. 9A or a pattern in which dots are arranged in a lattice as illustrated in FIG. 9B. The dots may have any shape, such as a circle or a regular polygon.

The pattern of the adhesive layer 209 does not necessarily have to be periodic, and any pattern may be used as long as the pattern has regions with and without the adhesive layer 209.

The aluminum film 106 is wound in a cylindrical tube shape around the entire outer peripheral surface of the transparent tube 105, and the transparent tube 105 and the aluminum film 106 are adhered to each other via the adhesive layer 209. Here, since the adhesive layer 209 has a periodic pattern, there are regions on a surface of the aluminum film 106 where the adhesive layer 209 is not present, and in these regions, the transparent tube 105 and the aluminum film 106 do not come into contact with each other, creating an air layer 104. That is, the air layer 104 is present around the adhesive layer 209. As described above, by forming the adhesive layer 209 in a periodic pattern, the air layer 104 may be formed by adhering the aluminum film 106 to the transparent tube 105 while allowing the adhesive layer 209 to function as a spacer.

The pattern of the adhesive layer 209 is preferably a pattern in which a ratio of an area of the adhesive layer 209 to an area of the surface of the aluminum film 106 is 3% to 30%. With such a pattern, the aluminum film 106 may be adhered to the transparent tube 105 with sufficient strength, and an area of the air layer 104 may be made sufficiently large.

An adhesive layer 209 having a similar pattern may be provided on an outer surface of the aluminum film 106 (main surface that faces the light-shielding tube 107 when the aluminum film 106 is wound around the transparent tube 105), and the aluminum film 106 and an inner peripheral surface of the light-shielding tube 107 may be adhered to each other via the adhesive layer 209. A position of the aluminum film 106 relative to the light-shielding tube 107 may be fixed while forming the air layer 108 between the aluminum film 106 and the light-shielding tube 107.

### Modification 7 of Embodiment 1

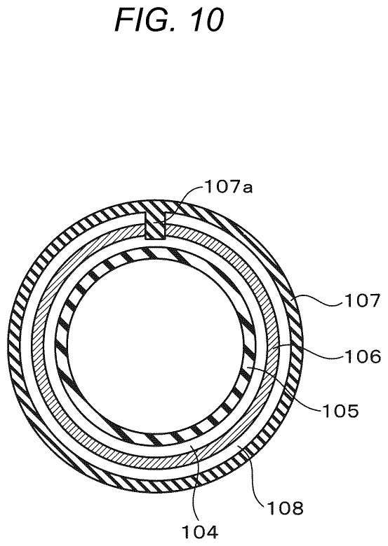

In Modification 7 of Embodiment 1, the flow path tube 100 according to Embodiment 1 is changed as follows. FIG. 10 is a cross-sectional view of a flow path tube 100 according to Modification 7 of Embodiment 1. As illustrated in FIG. 10, the aluminum film 106 is wound in a cylindrical tube shape that is C-shaped in a cross section perpendicular to the axis, the transparent tube 105 and the aluminum film 106 are disposed at a predetermined interval, and the air layer 104 is present. The inner peripheral surface of the light-shielding tube 107 has a protrusion 107a that protrudes inward. The protrusion 107a is fitted into a gap in the aluminum film 106. The protrusion 107a may prevent displacement of the aluminum film 106.

### Other Modifications

In the fluid sterilization device 1 according to Embodiment 1, the light source units 110a, 110b are respectively provided on the inlet 101 side and the outlet 102 side. The light source unit 110a may be provided only on the inlet 101 side in a case where the flow path tube 100 is short. In this case, a reflective film 160 that reflects light from the light source unit 110a may be disposed on an end surface of the flow path tube 100 on the second end side. The light from the light source unit 110a may be reflected by the reflective film 160, and the sterilization efficiency may be improved by irradiating the fluid with the reflected light.

The light source unit 110 may be provided only on the outlet 102 side. In this case as well, the sterilization efficiency may be improved by providing the reflective film 160 on the end surface of the flow path tube 100 on the first end side.

What is claimed is:

1. A fluid sterilization device comprising:
a flow path tube through which a fluid flows, the flow path tube having a cylindrical tube shape; and
a light source unit configured to irradiate an inside of the flow path tube with ultraviolet light, wherein
the flow path tube includes
a transparent tube through which the ultraviolet light is transmitted, and
an aluminum film wound around an outer peripheral surface of the transparent tube, and
the aluminum film is disposed not to be in close contact with at least a portion of the outer peripheral surface of the transparent tube and to have a first air layer.

2. The fluid sterilization device according to claim 1, wherein
the aluminum film is wound such that the aluminum film overlaps to have a first portion of the aluminum film on a second portion of the aluminum film, and an adhesive layer is provided between the first portion and the second portion.

3. The fluid sterilization device according to claim 1, wherein
the aluminum film is disposed to have the first air layer between the aluminum film and the outer peripheral surface of the transparent tube entirely.

4. The fluid sterilization device according to claim 1, further comprising:
an adhesive layer on a portion of an inner surface of the aluminum film, wherein
the transparent tube and the aluminum film are adhered by the adhesive layer, and the first air layer is present around the adhesive layer.

5. The fluid sterilization device according to claim 4, wherein
the adhesive layer has a periodic pattern.

6. The fluid sterilization device according to claim 1, wherein
the flow path tube further includes a light-shielding tube that covers an outer periphery of the aluminum film and shields the ultraviolet light from the light source unit.

7. The fluid sterilization device according to claim 6, further comprising:
a second air layer between the aluminum film and the light-shielding tube.

8. The fluid sterilization device according to claim 6, wherein
the aluminum film is wound in a cylindrical tube shape that is C-shaped in a cross section perpendicular to an axis,
the light-shielding tube includes a protrusion that protrudes inward on an inner peripheral surface thereof, and
the protrusion is fitted into a gap in the aluminum film formed by the C-shaped.
